(19) United States
(12) Patent Application Publication
(10) Pub. No.: US 2025/0001830 A1
(43) Pub. Date: Jan. 2, 2025

(54) METHOD FOR SETTING AN AIR CONDITIONER

(71) Applicant: MAHLE INTERNATIONAL GMBH, Stuttgart (DE)

(72) Inventors: Marcel GÜNTER, Stuttgart (DE); Kristian HAASE, Leinfelden-Echterdingen (DE); Lars LUDWIG, Altbach (DE); Marco ROTH, Stuttgart (DE)

(21) Appl. No.: 18/753,078

(22) Filed: Jun. 25, 2024

(30) Foreign Application Priority Data
Jun. 27, 2023 (DE) 102023206035.3

(51) Int. Cl. B60H 1/00; G05B 13/02

(52) U.S. Cl. CPC B60H 1/0073; G05B 13/0265

(57) ABSTRACT

A method for individualized setting of an air conditioner in a vehicle for a user using a control structure is provided. In doing so, a modeling data packet is acquired and a comfort model is subsequently trained in an AI unit. A setting data packet is also acquired and sent to the trained comfort model. Individualized settings are predicted by the comfort model and the air conditioner is set on the basis thereof.

A control architecture for executing the method is provided.

### CROSS-REFERENCE TO RELATED APPLICATIONS

This application claims priority from German Patent Application No. 10 2023 206 035.3, filed on Jun. 27, 2023, the entirety of which is hereby incorporated by reference herein.

The invention relates to a method for individualized setting of an air conditioner in a vehicle using a control architecture according to the preamble of claim 1. The invention also relates to the control architecture for executing the method.

An air conditioner user can set the temperature by changing numerous parameters based on the user's thermal perceptions. The air conditioner can be set by a climate control system based on an engine performance map, thus simplifying use of the air conditioner. The thermal perceptions of an individual user may be very specific, however. Conventional performance map-based climate controls are configured for “average” people, and cannot be adjusted to individual users. If the user does not feel comfortable with performance map-based climate control, the air conditioner has to be adjusted manually. AI-supported comfort models (AI: artificial intelligence) that can be adjusted to individual preferences have also been proposed. The intention is to make existing comfort models available for other vehicles.

User-specific air conditioner controls are disclosed in DE 10 2020 107178 A1, DE 10 2015 221416 A1, and DE 10 2018 113074 A1, for example. DE 10 2018 129417 A1 also discloses a universal AI-supported control for devices.

The object of the invention is to therefore create a better, or at least different, method for setting an air conditioner, without the disadvantages of the prior art. The object of the invention is to also create a control architecture with which this method can be executed.

These problems are solved according to the invention by the subject matter of the dependent claims. Advantageous embodiments are the subject matter of the dependent claims.

The present invention is based on the general concept of training an AI unit and creating an individualized comfort model for a user.

The method according to the invention is intended for individualized setting of an air conditioner in a vehicle for a user, and is carried out by a control architecture. A modeling loop and setting loop are executed repeatedly in the method. First, at least one modeling data packet for the user is acquired in the modeling loop. Subsequently, a comfort model is trained in an AI unit using data from at least one of the modeling data packets for the user. A setting data packet for the vehicle is then acquired in the setting loop and sent to the trained comfort model. At this point, individualized settings for the air conditioner are predicted using the comfort model based on the data in the setting data packet. The air conditioner is then set according to the individual preferences of the user.

The modeling loop is executed repeatedly with data from the modeling data packets to train the comfort model. The modeling loop can be stopped as soon as the comfort model has been trained. A new modeling loop can then be started. Numerous modeling data packets can be used in each modeling loop. The modeling data packets can be obtained by using the air conditioner repeatedly, and then used to train the comfort model. The comfort model can thus be further adjusted to, or individualized for, the user through use of the air conditioner. The setting loop is executed repeatedly in order to be able to predict the individualized settings for the air conditioner based on the data in the setting data packet. The user-preferred settings are necessary for using the air conditioner, and are predicted by the trained comfort model. In other words, the comfort model becomes increasingly individualized through the use of the air conditioner, and the air conditioner is more precisely set to the preferences of the user based on the individualized comfort model with each subsequent use. The comfort model is trained using data from the modeling data packet for the user, thus reducing the amount of computing in the vehicle. Furthermore, the trained comfort model can be exported to other vehicles used by the same user. Consequently, an individualized comfort model can be obtained with the method that is trained in a centralized manner. It should also be clear that numerous comfort models can also be trained for numerous users using this method.

The individualized settings for the air conditioner in the context of the present invention are understood to be those settings that correspond to the user's preferences, or that are based on the user's perceptions. The individualized settings of the air conditioner can contain target settings for the air conditioner in the vehicle. The target settings for the air conditioner can be individualized. In other words, the trained comfort model can provide all of the target settings for the air conditioner. The target settings for the air conditioner are the optimal settings for a specific user in specific circumstances.

The data in the modeling data packet in the context of the present invention are data or values relevant for training the comfort model, or that need to be taken into account when training the comfort model. The data in the setting data packet in the context of the present invention are data or values relating to setting the air conditioner that need to be taken into account in the comfort model when predicting individualized settings. The modeling data packet and the setting data packet may contain some identical data or values. The modeling data packet and the setting data packet can also contain some different data or values. In particular, the modeling data packet can contain the setting data packet and other information.

The modeling data packet and/or setting data packet can contain context data acquired with sensors in the motor vehicle. The context data can comprise at least one context value for the vehicle. The at least one context value can preferably be the interior temperature, and/or exterior temperature, and/or humidity, and/or the position of the sun, and/or light intensity, and/or air pressure. It should be understood that additions can be made to this list. The context data can be taken into account when training the comfort model and/or setting the air conditioner, such that the comfort model can be individualized, and/or the air conditioner can be set to the individual preferences of the user.

The modeling data packet and/or the setting data packet can contain user data. The user data can include at least one user value for the user. The at least one user value can preferably be physiological information such as sitting position, and/or user identity, and/or skin temperature, and/or pulse rate, and/or respiratory rate, and/or age, and/or gender, and/or state of clothing, and/or emotional state, and/or biometric inputs, and/or physiological inputs. It should be understood that additions can be made to this list. The user data can be acquired with sensors in the vehicle. The sensors can be a camera or infrared camera installed in the vehicle. The user data can also be obtained from a mobile device carried by the user. The user data can be obtained from information stored in the mobile device. By way of example, it can be determined from calender data whether the user has planned on participating in an athletic activity.

The modeling data packet can be created with manual user input. This user input can be a manual change made to the current individualized setting of the air conditioner. The user input can then be incorporated in the modeling data packet, potentially with additional data, and thus used in the training process for the comfort model. The modeling data packet can be modified every time user input takes place. User input is manual input from the user in which a change is made to the current setting of the air conditioner. The user input can take place, for example, when a desired perception is not satisfied by the predicted, individualized, settings and therefore by the current comfort model.

The creation of the modeling data packet can be initiated by user input, and the data in the current modeling data packet can be used in the comfort model. The current modeling data packet comprises current data input and potentially other data, such that the comfort model can be individualized to the user and the user's perceptions. The modeling data packet can also contain the context data and/or the user data specified above, thus allowing the comfort model to be trained on the basis of the user input in the context of the currently available context data and/or the currently available user data. Because the user input is entered manually, the modeling data packet can be created without a predefined input frequency.

The user input can comprise setting data entered by the user. The setting data can then contain at least one setting value. The at least one setting value can preferably be a desired temperature, and/or fan level, and/or heated seat setting, and/or heating surface setting, and/or heater setting. It should be understood that additions can be made to this list. The user input can also contain optimization data entered by the user. The optimization data can then contain at least one optimization value. The at least one optimization value can preferably comprise inputs regarding user-specific perceptions. Consequently, information such as “head too cold,” “right leg too warm,” “fan is unpleasant,” etc. can be taken into account in the optimization data.

The modeling data packet can also be initiated at a predefined interval, if no user input takes place within a predefined interval. As explained above, user input is entered manually by the user, and results in a change to the current individualized settings of the air conditioner. If the user makes no changes to the individualized settings, it can be assumed that the desired perceptions have been satisfied by the current comfort model or the individualized settings in the current circumstances. This can be regarded as positive feedback from the user. The predefined interval can be from 1 to 30 minutes, in particular from 5 to 20 minutes.

The setting loop can be executed at a predefined frequency. The predefined frequency can preferably 0.1 to 10 hertz, particularly preferably 1 Hz. The setting loop can be initiated independently of user input. Consequently, the air conditioner can be set without the user doing so manually, based on changes in the environmental conditions. Accordingly, the modeling loop and setting loop can be executed independently, and/or at different times. As explained above, the modeling loop can be initiated without a predefined frequency. Consequently, the modeling loop and the setting loop can be executed at different frequencies.

Offset settings can be created from the data in the modeling packet. The offset settings can then be stored in the vehicle and incorporated in the setting of the air conditioner. Once these offset settings have been used in the trained comfort model, they can be deleted. This means that data in the modeling data packet that have not yet been used in the current comfort model can also be used to set the air conditioner. The offset settings can make use of user input that has not yet been taken into account in the comfort model. The offset settings can contain offsets to the current settings, or the currently set values for the air conditioner, that are specifically desired by the user. By way of example, an offset setting can be an offset to the interior temperature set by the air conditioner, if the user wants to increase or decrease this temperature. If there are numerous modeling data packets that have not yet been used in the comfort model, each of these data packets can be successively used to create the offset settings.

The comfort model can be periodically trained with the method at predefined times, e.g. hourly, daily, or weekly. All of the modeling data packets can be stored between two successive times and used to train the comfort model. In other words, numerous modeling data packets for the user can be stored, e.g. in the vehicle and/or cloud storage, and the comfort model can be trained once using data from numerous data packets. In other words, creation of the modeling data packet does not necessarily relate to the training of the comfort model. The modeling data packets can be stored, e.g. in the vehicle or the cloud, until the comfort model has been trained, and then used by the trained comfort model. Not all of the modeling data packets have to be used for training the comfort model. In other words, the comfort model can also be trained with some of the modeling data packets. The comfort model can be trained periodically at predefined times—e.g. hourly, daily, or weekly. Obviously, the comfort model is not trained when no modeling data packets are available.

The modeling data packets can be weighted when training the comfort model. The weighting can be based on the time that has lapsed between two successive modeling data packets. If this interval is short, it can be assumed that the data in the first data packet did not obtain the desired results from the user's perspective, and are less relevant for training the comfort model. When the interval is long, it can be assumed that the data in the first data packet have obtained the desired results from the user's perspective, and are extremely relevant for training the comfort model. The terms “short” and “long” are relative. A “short” interval can be 1-5 minutes, and a “long” interval can be 10-30 minutes.

In one possible first embodiment of the method, the modeling loop can be executed in the vehicle. The comfort model can then be trained in the AI unit in the vehicle. The method can be entirely executed in the vehicle, without accessing the cloud.

In the first embodiment of the method, the comfort model in the modeling loop can be stored in the vehicle after training, and executed in the setting loop in the vehicle. The individualized settings can then be predicted directly in the vehicle. This means that the comfort model trained in the vehicle can be used.

In a possible second embodiment of the method, the modeling loop can be executed in the cloud. The modeling data packet for the user can then be sent to the cloud, and the comfort model can be trained in the AI unit in the cloud. The cloud is a network that provides computer resources such as servers, and/or storage, and/or applications.

With the second embodiment of the method, the modeling data packet can be stored in a memory in the vehicle, if it is not possible to send the modeling data packet for the user to the cloud. The modeling data packet can then be sent to the cloud as soon as this is possible. This means that data in the modeling data packet that could not be sent directly to the cloud can also be used to train the comfort model. If there are numerous modeling data packets that cannot be sent directly to the cloud, they can all be stored in the memory, and then sent collectively to the cloud. Consequently, all of these data packets can be used for training the comfort model without any data loss.

As explained above, the comfort model can be trained periodically at predefined times. All of the modeling data packets for the user can be stored in the vehicle or the cloud in between two successive times, and then used for training the comfort model. When all of the modeling data packets are stored in the vehicle, they can then be periodically sent to the cloud at predefined times. In other words, numerous modeling data packets for the user can be sent at the same time to the cloud. The comfort model can then be trained using all of the modeling data packets that have been sent at the same time.

The comfort model can be stored in a model pool in the cloud in the second embodiment of the method. To retrain the comfort model, the original comfort model can be accessed and then trained in the cloud. The comfort model in the model pool can then be replaced or updated by the new, current, and trained comfort model. The comfort model can also be sent from the model pool to the vehicle and stored therein. The comfort model can be sent from the model pool to the vehicle periodically, at predefined times. This means that the comfort model can be sent to the vehicle hourly, daily, or weekly. In particular, the comfort model can be sent from the model pool in the cloud to the vehicle after its training has been completed.

The second embodiment of the method can be executed in different ways. Three different ways shall be explained below in greater detail. It is clear that these versions can be expanded with the features described above. It is also clear that other versions can be obtained.

In the first version, the comfort model in the modeling loop can be stored in a model pool in the cloud after it has been trained. The comfort model can also be sent from the model pool to the vehicle and stored therein. The setting data packet can then be sent in the setting loop to the comfort model stored in the vehicle. The comfort model can then be executed in the vehicle and individualized settings can be predicted locally in the vehicle. The cloud is therefore only used in the modeling loop in the first version. As explained above, the modeling loop and setting loop can be executed at different frequencies. In particular, the modeling loop can be executed at a much lower frequency than the setting loop. This significantly reduces the amount of data sent to and received by the cloud.

In the second alternative, the comfort model in the modeling loop can be stored in a model pool in the cloud after it has been trained. The setting data packet can then be sent from the vehicle to the comfort model stored in the model pool in the setting loop. The comfort model can then be executed in the cloud, and the individualized settings can be predicted in the cloud and then sent to the vehicle. In the second alternative, the comfort model is therefore not stored in the vehicle, and the modeling loop and setting loop are both executed in the cloud.

In the third alternative, the comfort model in the modeling loop can be stored in a model pool in the cloud after it has been trained. The comfort model can also be sent from the model pool to the vehicle and stored therein. The setting data are sent in the setting loop to the comfort model stored in the vehicle, if it is not possible to send the setting data packet in the vehicle to the cloud. The comfort model is then executed in the vehicle and the individualized settings are predicted locally in the vehicle. If it is possible to the send the setting data packet in the vehicle to the cloud, this setting data packet is sent from the vehicle to the comfort model stored in the model pool. The comfort model is then executed in the cloud, and the individualized settings are predicted in the cloud and subsequently sent to the vehicle. The third alternative is therefore a hybrid composed of the first and second versions of the method.

The invention also relates to a control architecture for executing the method described above. The control architecture is designed to execute the method. Specifically, the control architecture is designed to repeatedly acquire modeling data packets for the user, repeatedly train a comfort model with data from the modeling data packets for the user in an AI unit, repeatedly acquire setting data packets for the vehicle and repeatedly send the setting data packets to the comfort model, repeatedly predict individualized settings for the air conditioner using the comfort model based on the data in the setting data packets, and repeatedly set the air conditioner in accordance with the individualized settings. It is understood that the control architecture contains the necessary hardware and/or software for executing the method. The necessary hardware and/or software can be part of the vehicle and/or the cloud. To avoid repetition, reference is made at this point to the explanations above.

Important features and advantages of the invention can be derived from the dependent claims, drawings, and the descriptions in reference to the drawings.

It is understood that the features specified above and explained below can be used not only in the given combinations but also in other combinations or in and of themselves, without abandoning the framework of the present invention.

Preferred exemplary embodiments of the invention are shown in the drawings and shall be explained below in greater detail, in which the same reference symbols are used for the same, similar, or functionally similar components.

Therein, schematically:

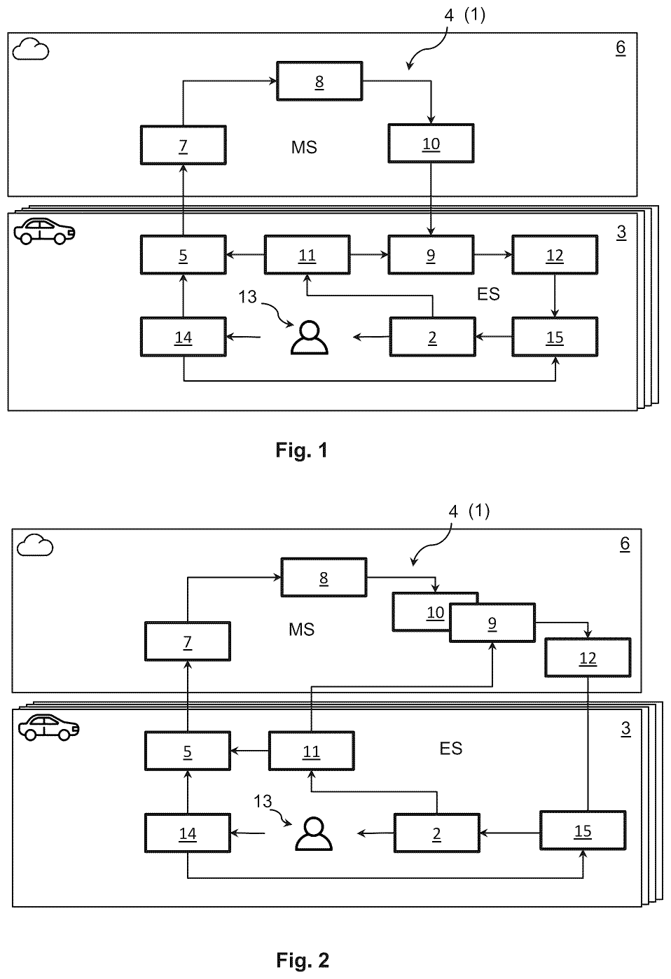

FIG. 1 shows a schematic sequence of the method according to the invention in a first alternative with the cloud;

FIG. 2 shows a schematic sequence of the method according to the invention in a second alternative with the cloud; and

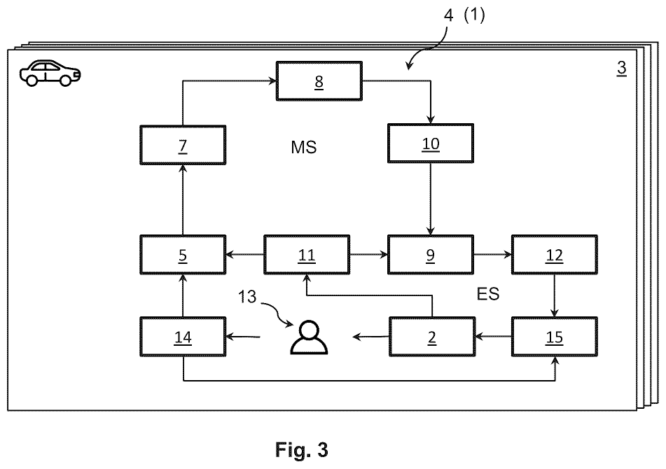

FIG. 3 shows a schematic sequence of the method according to the invention in a third alternative, without the cloud.

FIG. 1 shows a schematic sequence of a first version of the method 1 according to the invention. The method 1 is intended for individualized setting of an air conditioner 2 in a vehicle 3, and is executed by a control structure 4. A modeling loop MS and setting loop are executed repeatedly in the method 1.

A modeling data packet 5 is acquired in the modeling loop MS and sent to the cloud 6. The modeling data packet 5 is stored in a memory 7 in the cloud 6. A comfort model 9 is then trained with the data from the modeling data packet 5 in an AI unit 8 in the cloud 6. The trained comfort model 9 is then stored in a model pool 10. In the first version of the method 1, the comfort model 9 is also sent to the motor vehicle 3 and stored therein. A setting data packet 11 for the vehicle 3 is acquired in the setting loop ES and sent to the comfort model 9 stored in the vehicle 3. Individualized settings 12 are predicted using the comfort model 9 based on the data in the setting data packet 11. The individualized settings 12 are subsequently used for setting the air conditioner 2.

The setting data packet 11 can contain context data for the vehicle 3, e.g. interior temperature, and/or exterior temperature, and/or humidity, and/or the position of the sun, and/or light intensity, and/or air pressure. The setting data packet 11 can also contain user data, e.g. physiological information such as seating position, and/or user identity, and/or skin temperature, and/or pulse rate, and/or respiratory rate, and/or age, and/or gender, and/or state of clothing, and/or emotional state, and/or biometric inputs, and/or physiological inputs. The settings 12 for the air conditioner 2 can be predicted by the comfort model 9 based on the data in the setting data packet 11, and the air conditioner 2 can be set. The air conditioner 2 is consequently set in accordance with the preferences of the user 13.

The modeling loop MS is initiated by user input 14 in the method 1. The user 13 of the vehicle 3 enters the user input 14 manually if the user's desired thermal perception is not satisfied with the current individualized settings 12 of the air conditioner 2. The user input 14 can be setting data entered by the user 13, such as a desired temperature and/or fan level, and/or heated seat setting, and/or heated surface setting, and/or heater setting. The user input 14 can also be optimization data entered by the user, e.g. “head too cold,” “right leg too warm,” “fan is unpleasant,” etc.

The user input 14 is then combined with the setting data packet 11, which contains context data and user data, to obtain the modeling data packet 5, and sent to the cloud 6. The modeling data packet 5 is stored in the cloud 6 and used for further training of the comfort model 9. The current comfort model 9 is accessed in the model pool 10 and further trained in this case. After training, the comfort model 9 in the model pool 10 is updated, and the updated comfort model 9 is stored in the vehicle 3. The user input 14, together with the data from the setting data packet 11, is taken into account in the updated comfort model 9.

If it is not possible to send the modeling data packet 5, it is stored in the vehicle. In the first version of the method 1, offset settings 15 are created from the data in the modeling data packet 5 that has not been sent. The offset settings 15 are stored in the vehicle 3 and individualized settings 12 are corrected using the offset settings 15. The offset settings 15 can comprise offsets for the setting values that are to be used to set the air conditioner 2. Once the modeling data packet 5 has been sent to the cloud 6, the offset settings 15 are deleted.

FIG. 2 shows a schematic sequence of a second version of the method 1 according to the invention. The second version of the method 1 differs from the first version in that instead of sending the comfort model 9 to the vehicle 3, it is executed in the cloud 6. The individualized settings 12 are therefore predicted in the cloud 6, and subsequently sent to the vehicle 3, where the air conditioner 2 is then set. The offset settings 15 here can also contain offsets for the setting values for the air conditioner 2.

Another version of the method 1 can also be executed based on FIG. 1 and FIG. 2. In this version, the trained comfort model 9 is stored in the model pool 10 and the vehicle 3. If it is possible to transmit data to the cloud 6, the comfort model 9 in the model pool 10 is used, and the setting loop ES is executed in the version of the method 1 shown in FIG. 2. If it is not possible to transmit data to the cloud 6, the comfort model in the vehicle 3 is used, and the setting loop ES is executed in the version of the method 1 shown in FIG. 1.

FIG. 3 shows a schematic sequence of a third version of the method 1 according to the invention, without the cloud. The modeling loop MS and setting loop ES are executed locally in the vehicle 3 in this case. The third version of the method 1 otherwise corresponds to the second version of the method 1.

This specification can be readily understood with reference to the following Representative Paragraphs:
Representative Paragraph 1. A method (1) for individualized setting of an air conditioner (2) in a vehicle (3) for a user (13) using a control structure (4), wherein, in a repeated modeling loop (MS):
   at least one modeling data packet (5) for the user (13) is acquired,
   a comfort model (9) is trained in an AI unit (8) with data from at least one modeling data packet (5) for the user (13), wherein, in a repeated setting loop (ES):
   a setting data packet (11) for the vehicle (3) is acquired and sent to the trained comfort model (9),
   individualized settings (12) for the air conditioner (2) are predicted by the comfort model (9) based on the data in the setting data packet (11), and
   the air conditioner (2) is set on the basis of the individualized settings (12).
Representative Paragraph 2. The method according to Representative Paragraph 1, characterized in that
   the creation of the modeling data packet (5) is initiated when user input (14) is entered manually by the user (13) to change the current individualized settings (12) of the air conditioner (2), and/or
   the creation of the modeling data packet (5) is initiated after a predefined time interval, if the user (13) does not manually enter any user input (14) to change the current individualized settings (12) of the air conditioner (2) within a predefined time interval.
Representative Paragraph 3. The method according to Representative Paragraph 1 or 2, characterized in that the setting loop (ES) is executed at a predefined frequency, preferably between 0.5 and 10 hertz, particularly preferably 1 hertz.
Representative Paragraph 4. The method according to any of the preceding Representative Paragraphs, characterized in that
   the offset settings (15) are created from data in the modeling data packet (5), stored in the vehicle (5), and used to set the air conditioner (2), and
   as soon as the offset data (15) are incorporated in the comfort model (9), they are deleted.
Representative Paragraph 5. The method according to any of the preceding Representative Paragraphs, characterized in that
   the comfort model (9) is trained periodically at a predefined time, wherein all modeling data packets (5) for the user (13) are stored between successive times, and used to train the comfort model (9), and/or
   the data from the modeling data packets (5) are weighted when training the comfort model (9).
Representative Paragraph 6. The method according to any of the preceding Representative Paragraphs, characterized in that
   the modeling loop (MS) is executed in the vehicle (3), and
   the comfort model (KM) is trained in the AI unit (8) in the vehicle (3).
Representative Paragraph 7. The method according to Representative Paragraph 6, characterized in that, in the modeling loop (MS):
   the comfort model (9) is stored in the vehicle (3) after it has been trained; and in the setting loop (ES):
   the comfort model (9) is executed in the vehicle (3) and the individualized settings (12) are predicted locally in the vehicle (3).
Representative Paragraph 8. The method according to any of the preceding Representative Paragraphs, characterized in that
   the modeling loop (MS) is executed in the cloud (6),
   the modeling data packet (5) acquired for the user (13) is sent to the cloud (6), and
   the comfort model (KM) is trained in the AI unit (8) in the cloud (6).
Representative Paragraph 9. The method according to Representative Paragraph 8, characterized in that
   if it is not possible to send the modeling data packet (5) for the user (13) to the cloud (6), the modeling data packet (5) is stored in the vehicle (3), and
   as soon as it is possible to send the modeling data packet (5) for the user (13) to the cloud (6), the modeling data packet (5) is sent to the cloud (6) and deleted in the vehicle (3).
Representative Paragraph 10. The method according to Representative Paragraph 8 or 9, characterized in that
   all modeling data packets (5) for the user (13) are stored in the vehicle (3), and periodically sent at predefined times from the vehicle (3) to the cloud (6), and/or
   the comfort model (9) is stored in a model pool (10) in the cloud (6), and/or
   the comfort model (9) is stored in a model pool (10) in the cloud (6) and sent from the model pool (10) to the vehicle (3), and stored in the vehicle (3), and/or
   the comfort model (9) is stored in a model pool (10) in the cloud (6), and the current comfort model (9) is sent periodically, at predefined times, from the model pool (10) to the vehicle (3), and/or
   the comfort model (9) is stored in a model pool (10) in the cloud (6) and sent from the model pool (10) in the cloud (6) to the vehicle (3) after it has been fully trained.
Representative Paragraph 11. The method according to any of the Representative Paragraphs 8 to 10, characterized in that, in the modeling loop (MS):
   the comfort model (9) is stored in a model pool (10) in the cloud (6) after it has been trained,
   the comfort model (9) is sent from the model pool (10) to the vehicle (3) and then stored in the vehicle (3),
in the setting loop (ES):
   the setting data packet (11) is sent to the comfort model (9) stored in the vehicle (3),
   the comfort model (9) is executed in the vehicle (3) and the individualized settings (12) are predicted locally in the vehicle (3).
Representative Paragraph 12. The method according to any of the Representative Paragraphs 8 to 10, characterized in that, in the modeling loop (MS):
   the comfort model (9) is stored after it has been trained in a model pool (10) in the cloud (6),
in the setting loop (ES):
   the setting data packet (11) is sent from the vehicle (3) to the comfort model (9) stored in the model pool (10),
   the comfort model (9) is executed in the cloud (6), and the individualized settings (12) are predicted in the cloud (6) and subsequently sent to the vehicle (3).
Representative Paragraph 13. The method according to any of the Representative Paragraphs 8 to 10, characterized in that, in the modeling loop (MS):
   the comfort model (9) is stored after it has been trained in a model pool (10) in the cloud (6),
   the comfort model (9) is sent from the model pool (10) to the vehicle (3) and stored in the vehicle (3),
in the setting loop (ES):
   if it is not possible to send the setting data packet (11) for the vehicle (3) to the cloud (6), the setting data packet (11) is sent to the comfort model (9) stored in the vehicle (3), the comfort model (9) is executed in the vehicle (3), and the individualized settings (12) are predicted locally in the vehicle (3), and
   when it is possible to send the setting data packet (11) for the vehicle (3) to the cloud (6), the setting data packet (11) is sent from the vehicle (3) to the comfort model (9) stored in the model pool (10), the comfort model (9) is executed in the cloud (6), the individualized settings (12) are predicted in the cloud (6), and subsequently sent to the vehicle (3).
Representative Paragraph 14. A control architecture (4) for executing the method (1) according to any of the preceding Representative Paragraphs, wherein the control architecture (4) is designed to:
   repeatedly acquire modeling data packets (5) for the user (13),
   repeatedly train the comfort model (9) with data from the modeling data packets (5) for the user (13) in an AI unit (8),
   repeatedly acquire setting data packets (11) for the vehicle (3) and repeatedly send these setting data packets (11) to the comfort model (9),
   repeatedly predict individualized settings (12) for an air conditioner (2) in the vehicle (3) using the comfort model (9), based on data in the setting data packets (11),
   repeatedly set the air conditioner (2) in accordance with the individualized settings (12).

1. A method for individualized setting of an air conditioner in a vehicle for a user using a control structure, wherein, in a repeated modeling loop:
at least one modeling data packet for the user is acquired,
a comfort model is trained in an AI unit with data from at least one modeling data packet for the user,
wherein, in a repeated setting loop:
a setting data packet for the vehicle is acquired and sent to the trained comfort model,
individualized settings for the air conditioner are predicted by the comfort model based on the data in the setting data packet, and
the air conditioner is set on the basis of the individualized settings.

2. The method according to claim 1, wherein
the creation of the modeling data packet is initiated when user input is entered manually by the user to change the current individualized settings of the air conditioner, and/or
the creation of the modeling data packet is initiated after a predefined time interval, if the user does not manually enter any user input to change the current individualized settings of the air conditioner within a predefined time interval.

3. The method according to claim 1, wherein the setting loop is executed at a predefined frequency, preferably between 0.5 and 10 hertz, particularly preferably 1 hertz.

4. The method according to claim 1, wherein the offset settings are created from data in the modeling data packet, stored in the vehicle, and used to set the air conditioner, and
as soon as the offset data are incorporated in the comfort model, they are deleted.

5. The method according to claim 1, wherein
the comfort model is trained periodically at a predefined time, wherein all modeling data packets for the user are stored between successive times, and used to train the comfort model, and/or
the data from the modeling data packets are weighted when training the comfort model.

6. The method according to claim 1, wherein
the modeling loop is executed in the vehicle, and
the comfort model (KM) is trained in the AI unit in the vehicle.

7. The method according to claim 6, wherein at, in the modeling loop:
the comfort model is stored in the vehicle after it has been trained; and in the setting loop:
the comfort model is executed in the vehicle and the individualized settings are predicted locally in the vehicle.

8. The method according to claim 1, wherein
the modeling loop is executed in the cloud,
the modeling data packet acquired for the user is sent to the cloud, and
the comfort model (KM) is trained in the AI unit in the cloud.

9. The method according to claim 8, wherein
if it is not possible to send the modeling data packet for the user to the cloud, the modeling data packet is stored in the vehicle, and
as soon as it is possible to send the modeling data packet for the user to the cloud, the modeling data packet is sent to the cloud and deleted in the vehicle.

10. The method according to claim 8, wherein
all modeling data packets for the user are stored in the vehicle, and periodically sent at predefined times from the vehicle to the cloud, and/or
the comfort model is stored in a model pool in the cloud, and/or
the comfort model is stored in a model pool in the cloud and sent from the model pool to the vehicle, and stored in the vehicle, and/or
the comfort model is stored in a model pool in the cloud, and the current comfort model is sent periodically, at predefined times, from the model pool to the vehicle, and/or
the comfort model is stored in a model pool in the cloud and sent from the model pool in the cloud to the vehicle after it has been fully trained.

11. The method according to claim 8, wherein, in the modeling loop:
the comfort model is stored in a model pool in the cloud after it has been trained,
the comfort model is sent from the model pool to the vehicle and then stored in the vehicle,
in the setting loop:
the setting data packet is sent to the comfort model stored in the vehicle,
the comfort model is executed in the vehicle and the individualized settings are predicted locally in the vehicle.

12. The method according to claim 8, wherein, in the modeling loop:
the comfort model is stored after it has been trained in a model pool in the cloud,
in the setting loop:
the setting data packet is sent from the vehicle to the comfort model stored in the model pool,
the comfort model is executed in the cloud, and the individualized settings are predicted in the cloud and subsequently sent to the vehicle.

13. The method according to claim 8, wherein, in the modeling loop:
the comfort model is stored after it has been trained in a model pool in the cloud,
the comfort model is sent from the model pool to the vehicle and stored in the vehicle,
in the setting loop:
if it is not possible to send the setting data packet for the vehicle to the cloud, the setting data packet is sent to the comfort model stored in the vehicle, the comfort model is executed in the vehicle, and the individualized settings are predicted locally in the vehicle, and
when it is possible to send the setting data packet for the vehicle to the cloud, the setting data packet is sent from the vehicle to the comfort model stored in the model pool, the comfort model is executed in the cloud, the individualized settings are predicted in the cloud, and subsequently sent to the vehicle.

14. A control architecture for executing the method according to claim 1, wherein the control architecture is designed to:
repeatedly acquire modeling data packets for the user,
repeatedly train the comfort model with data from the modeling data packets for the user in an AI unit,
repeatedly acquire setting data packets for the vehicle and repeatedly send these setting data packets to the comfort model,
repeatedly predict individualized settings for an air conditioner in the vehicle using the comfort model, based on data in the setting data packets,
repeatedly set the air conditioner in accordance with the individualized settings.
